(19) United States
(12) Patent Application Publication
(10) Pub. No.: US 2022/0099220 A1
(43) Pub. Date: Mar. 31, 2022

(54) PIPE SUPPORT

(71) Applicant: Green Link Holdings, LLC, Kalamazoo, MI (US)

(72) Inventors: Phillip C. Georgeau, Kalamazoo, MI (US); Lisa Anne Mulder, Plainwell, MI (US); Ondrej Pekarovic, Kalamazoo, MI (US)

(21) Appl. No.: 17/300,307

(22) Filed: Sep. 30, 2020

(51) Int. Cl. F16L 3/227

(52) U.S. Cl. CPC F16L 3/227

(57) ABSTRACT

A support structure for supporting items on a roof structure comprises a tubular metal support structure. A lower surface of the tubular metal support structure may be adhesively secured to an exterior roof surface without use of mechanical fasteners. A pipe or other item may be secured to an upper portion of the tubular metal support structure.

### BRIEF DESCRIPTION OF THE DRAWINGS

In the drawings:

FIG. 1 is a partially fragmentary perspective view of supports positioned on a roof of a building;

FIG. 2 is an isometric view of a support according to one aspect of the present disclosure;

FIG. 3 is an end view of the support of FIG. 2; and

FIG. 4 is an enlarged view of a portion of the support of FIG. 2;

FIG. 5 is an isometric view of a support;

FIG. 6 is an isometric view of the support of FIG. 5;

FIG. 7 is a right-hand side elevational view of the support of FIG. 5;

FIG. 8 is a left-hand side elevational view of the support of FIG. 5;

FIG. 9 is a front elevational view of the support of FIG. 5;

FIG. 10 is a rear elevational view of the support of FIG. 5;

FIG. 11 is a top plan of the support of FIG. 5; and

FIG. 12 is a bottom plan view of the support of FIG. 5.

### DETAILED DESCRIPTION OF EMBODIMENTS

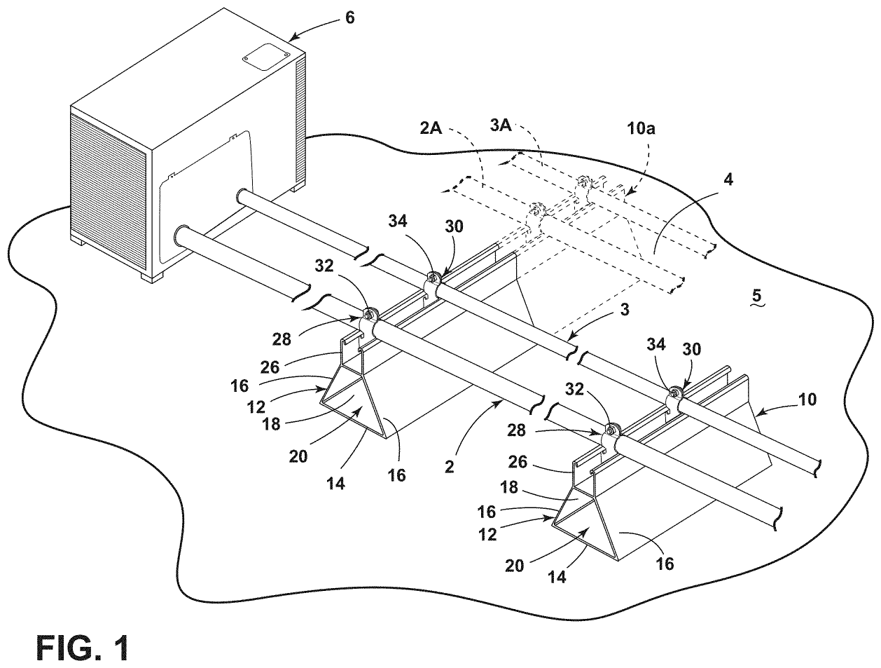

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Additionally, unless otherwise specified, it is to be understood that discussion of a particular feature or component extending in or along a given direction, or the like, does not mean that the feature or component follows a straight line or axis in such a direction or that it only extends in such direction or on such a plane without other directional components or deviations, unless otherwise specified.

With reference to FIG. 1, one or more items 2 and 3 may be supported on a surface 4 of a roof 5 by one or more supports 10. In the illustrated example, the items 2 and 3 may comprise pipes or tubes that are operably connected to a rooftop unit 6. Rooftop unit 6 may comprise an air-conditioning unit or virtually any other unit requiring tubes or other items to be connected thereto. It will be understood that the supports 10 may be utilized to support a wide range of items, and the present disclosure is not limited to any specific pipe or other item. In general, the roof 5 may comprise a low slope roof, and the surface 4 may have a small slope to facilitate drainage of water. However, it will be understood that the surface 4 may have a more substantial slope, and the supports 10 may be utilized to support items on virtually any sloped or non-sloped surface. Furthermore, the supports 10 could be used to support items on other surfaces (e.g., a floor or wall), and the present disclosure is not limited to any particular application.

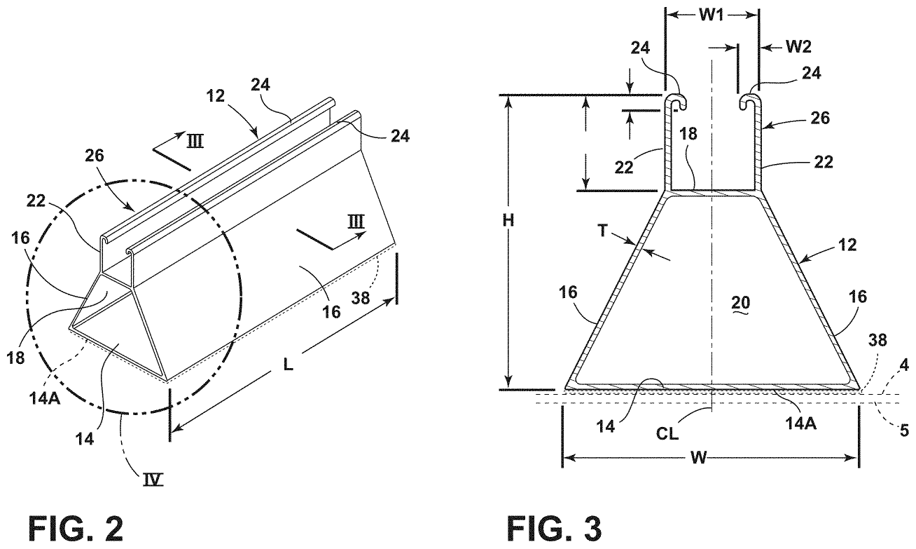

With further reference to FIGS. 2-4, the supports 10 comprise a body 12. The body 12 preferably comprises an aluminum extrusion having a base wall 14, sidewalls 16, and an upper wall 18 that together define a space 20. In the illustrated example, the sidewalls 14, 16, and 18 are substantially planar, and the space 20 forms an isosceles trapezoid in cross section. However, it will be understood that the present disclosure is not limited to any specific shape.

Referring to FIG. 3, the body 12 further includes upwardly extending walls 22 having curved upper ends 24 that are generally in the form of J-shape hooks. The upper portion 26 of body 12 formed by walls 22 and curved ends 24 may be configured to engage and receive clamps 28 and 30 to thereby secure pipes or other items 2 and 3 to the supports 10. The clamps 20 and 30 may include fasteners 32 and 34, respectively, that are tightened to secure the items 2 and 3 to the upper portions 26 of supports 10. The upper portion 26 and clamps 20 and 30 may be substantially similar to known supports, such that a detailed description of these features are not believed to be required.

Referring again to FIGS. 2 and 3, the body 12 may be substantially symmetric about a vertical plane (CL). It will be understood, however, that the body 12 may be asymmetrical. In the illustrated example, the body 12 has a width “W” of about 5 inches, and a height “H” of around 5 inches. A height “H1” of upper portion 26 is about 1.625 inches, and a width “W1” of upper portion 26 is about 1.625 inches. A height “H2” of curved end 24 may be about 0.281 inches, and a width “W2” of curved end 24 may be about 0.375 inches. A thickness “T” of walls 14, 16, 18, and 22 may be about 0.10 inches. It will be understood that the present disclosure is not limited to any specific dimensions, and the body 12 may have dimensions that are significantly larger or small than the dimensions noted above. The body 12 may comprise a homogeneous one-piece extruded aluminum structure. However, the present disclosure is not necessarily limited to a homogeneous one-piece structure, and body 12 could comprise two or more pieces that are joined to form a one-piece structure. The length “L” (FIG. 2) of body 12 is preferably at least about four inches long, and more preferably about 8 inches. However, the length “L” could be significantly greater than 8 inches, or the length could be significantly less than four inches if required for a particular application. Furthermore, additional supports 10A (FIG. 1) could be aligned to provide support for additional items 2A, 3A as required for a particular application.

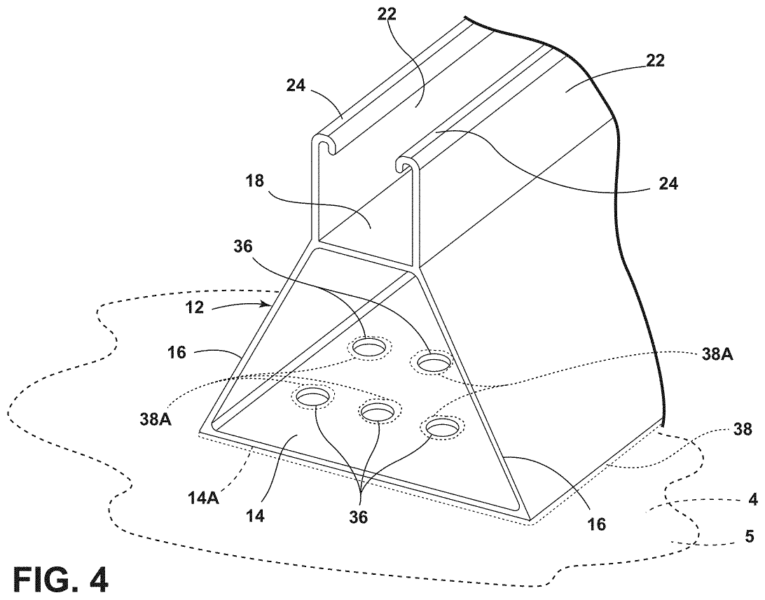

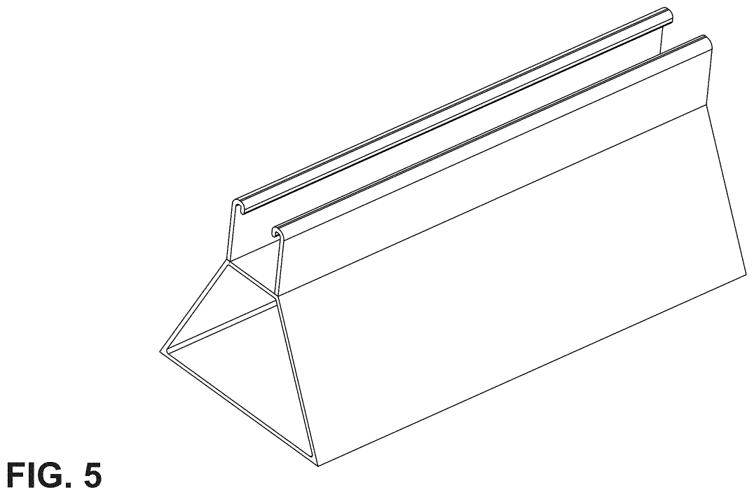

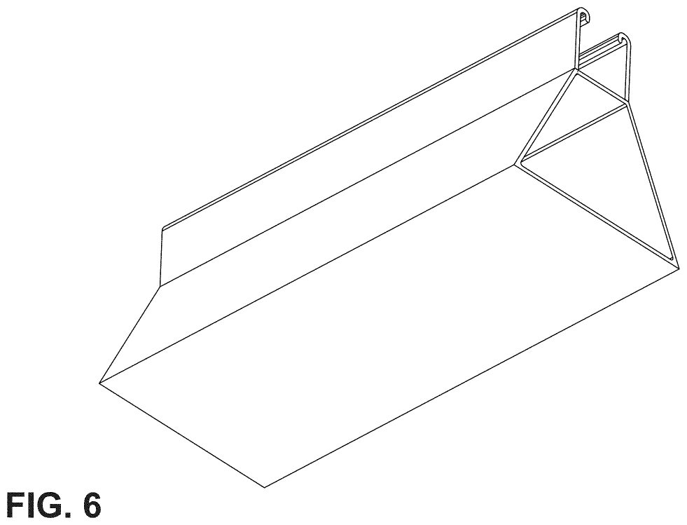

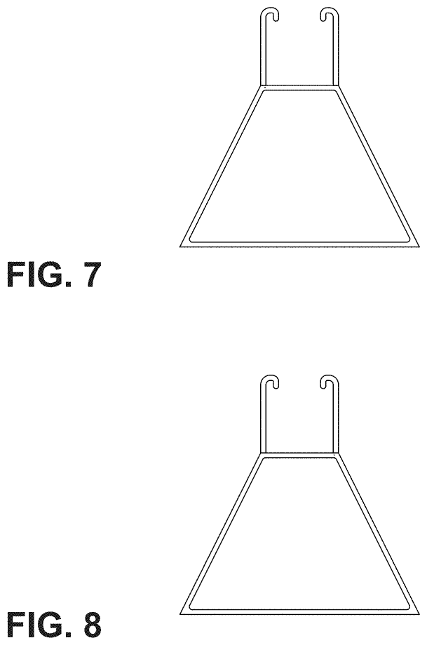

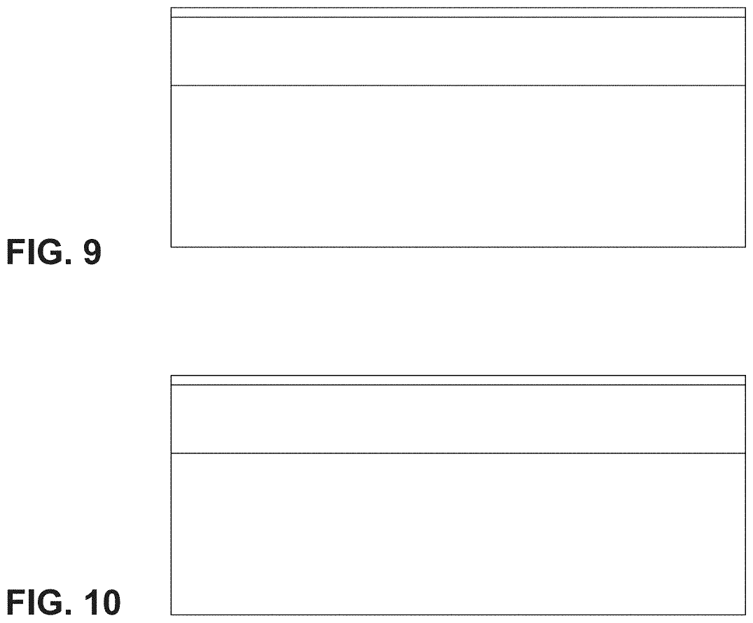

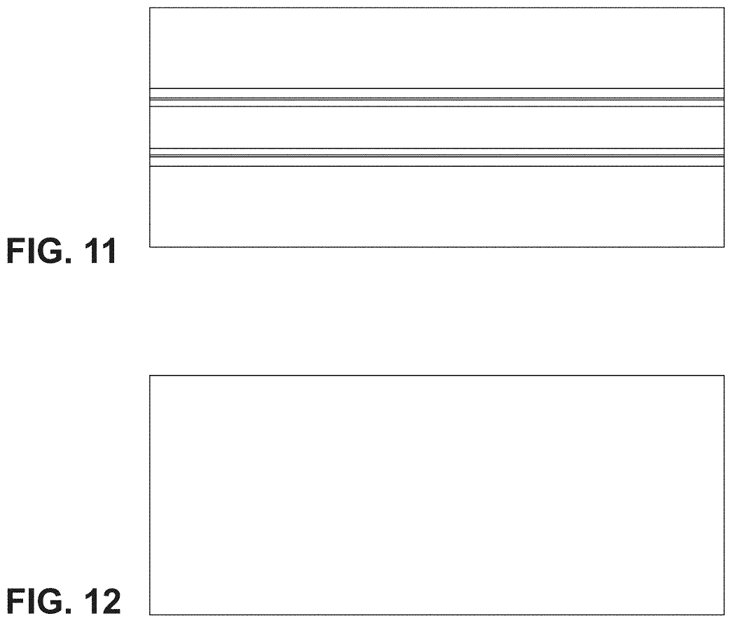

With reference to FIG. 4, the base wall 14 of body 12 may optionally include one or more openings 36. Openings 36 may be utilized to ensure that the body 12 is secured to a surface 4 of roof 5 by adhesive 38, which may include portions 38A that are least partially disposed in openings 36. In particular, roof surface 4 may comprise a roof membrane of a known type, such as EPDM, PVC, or TPO, and the body 12 of support 10 may be adhesively secured to the surface 4 utilizing a suitable adhesive 38. For example, if surface 4 comprises PVC or TPO, the body 10 may be secured to the surface 4 utilizing M-1® moisture curing adhesive available from Chem Link, Inc. of Schoolcraft, Michigan. However, it will be understood that other adhesives or fasteners may also be utilized. If surface 4 of roof 5 comprises EPDM, two-sided splicing tape of a type normally used for splicing EPDM membranes may be utilized to secure the body 12 of supports 10 to the surface 4. Specifically, the two-sided tape may be positioned between lower surface 14a of base wall 14 and surface 4 to thereby adhere the body 12 to surface 4 of roof 5. Although the openings 36 (FIG. 4) may be utilized in connection with adhesive, the openings 36 are optional, and body 12 may be secured to surface 4 of roof 5 utilizing two-sided tape or adhesive if body 12 has openings 36 or if body 12 does not include openings 36.

Referring again to FIG. 1, the support 10 of the present disclosure provides a very secure and durable support to secure various items, such as pipes 2 and 3 to a surface 4 of a roof 5. In particular, the one-piece aluminum construction of the body 12 provides a very strong, rigid, and durable structure that withstands the environmental conditions that may be present on a roof of a building. Furthermore, the supports 10 are stable, and are not prone to tipping or other stability issues.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only.

Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

What is claimed is:

1. A support structure for supporting items on a roof surface, the support structure comprising:
an elongated extrusion having a) a substantially planar lower sidewall defining a length and a width; b) an upper sidewall that is substantially planar and generally parallel to the lower sidewall, the upper sidewall defining a length and a width; c) a pair of substantially planar sidewalls, each having lower portions joined to opposite edge portions of the lower sidewall and upper portions joined to opposite edge portions of the upper sidewall; d) a pair of substantially planar upper walls having lower portions joined to the opposite edge portions of the upper sidewall, the upper walls having upper edges that are spaced apart to form a channel that opens upwardly wherein each upper edge includes a J-shaped flange;
and wherein the lower sidewall, the upper sidewall, the sidewalls, and the upper walls comprise one homogeneous piece of rigid material.

2. The support structure of claim 1, wherein:
the lower sidewall, the upper sidewall, and the sidewalls define an elongated trapezoidal interior space.

3. The support structure of claim 2, wherein:
the elongated extrusion includes openings at opposite ends thereof forming opposite ends of the elongated trapezoidal interior space.

4. The support structure of claim 1, wherein:
the elongated extrusion has a substantially uniform cross-sectional shape.

5. The support structure of claim 1, wherein:
at least one of the lower sidewall, the upper sidewall, and the sidewalls have a substantially uniform thickness.

6. The support structure of claim 5, wherein:
the lower sidewall, the upper sidewall, the sidewalls, and the upper walls have substantially uniform thicknesses.

7. The support structure of claim 6, wherein:
the lower sidewall, the upper sidewall, the sidewalls, and the upper walls have substantially equal thicknesses.

8. The support structure of claim 1, wherein:
the lower sidewall includes a plurality of openings therethrough that are configured to receive adhesive to secure the extrusion to a roof surface.

9. The support structure of claim 1, wherein:
the rigid material comprises aluminum.

10. The support structure of claim 7, wherein:
the width of the lower sidewall is about 4-6 inches;
the width of the upper sidewall is about 1-2 inches;
the height of the extrusion from a lower surface of the lower sidewall to the upper edges of the upper sidewalls is about 4-6 inches;
the extrusion has a length of about 4-12 inches; and
the lower sidewall, the upper sidewall, the sidewalls, and the upper walls have a thickness of about 0.05-0.20 inches.

11. The support structure of claim 1, wherein:
the upper edges of the upper walls have inwardly-curved portions that are configured to engage clamps to secure one or more pipes to the extrusion.

12. A method of securing a pipe to a roof, the method comprising:
providing a tubular metal support structure having an upper portion and a lower surface;
adhesively securing the lower surface of the tubular metal support structure to an exterior roof surface of a roof membrane without use of mechanical fasteners penetrating the roof membrane by bringing adhesive into contact with the lower surface of the tubular metal support structure and the exterior roof surface of the roof membrane; and
securing a pipe to the upper portion of the tubular metal support structure.

13. The method of claim 12, wherein:
the tubular metal support structure includes a lower sidewall having a plurality of openings therethrough; and includes:
causing at least some adhesive to be disposed in the openings.

14. The method of claim 12, wherein:
the lower surface of the tubular metal support structure is adhesively secured to the exterior roof surface using two-sided adhesive tape.

15. The method of claim 12, including:
fabricating the tubular metal support structure by extruding aluminum.

16. The method of claim 15, wherein:
the tubular metal support structure comprises a homogenous single piece of aluminum.

17. The method of claim 12, wherein:
the upper portion of the tubular metal support structure includes an upwardly-opening channel; and
the pipe is secured to the upper portion of the tubular metal support structure using clamps that engage the upwardly-opening channel.

18. The method of claim 12, wherein:
the tubular metal support structure has a substantially uniform cross-sectional shape.
